(19) United States
(12) Patent Application Publication
(10) Pub. No.: US 2013/0326385 A1
(43) Pub. Date: Dec. 5, 2013

(54) SYSTEM AND METHOD FOR CREATING AN AUTO-JOURNALING CALENDAR APPLICATION

(71) Applicant: Life of Two, San Francisco, CA (US)

(72) Inventor: Tyson Verstraete, San Francisco, CA (US)

(21) Appl. No.: 13/887,225

(22) Filed: May 3, 2013

Related U.S. Application Data
(60) Provisional application No. 61/642,348, filed on May 3, 2012.

(51) Int. Cl. G06F 3/0484

(52) U.S. Cl. CPC G06F 3/0484
USPC 715/771

(57) ABSTRACT

A system and method for building an auto-journaling calendar application is provided. An advanced calendar application is able to allow users to track not only appointments but their daily lives with data tracking methods. A system of tracking contextual events in the calendar allows it to provide a rich and useful interface that provides a better overview of a person's life. In the exemplary calendar application a summary of information can also be provided to help focus and clarify the information to improve its relevance within the calendar application.

### BACKGROUND

Electronic calendars are decades old and virtually every computer ever built had some form of calendar application for user's to track events and appointments. But calendar applications like most applications haven't changed much in 40 years. One of the biggest changes is the concept of a shared calendar between two or more people. Even with these advancement applications like calendar, contacts, task organizers and note-pad takers have become richer but limited to their own interfaces and their own data. This closed-world effect is sometimes called the silo-effect and limits each application to its own data and its own interface. This is especially obvious on small platforms like mobile phones, smartphones and tablet computers. In these environments, due to the lack of screen space, users are constantly flipping back and forth between applications to perform simple day to day tasks.

There is also a new class of application platforms being developed that encompass many sub-applications. For example an application platform like Facebook™ has many sub-applications within it, like games, calendar and messaging to name just a few. In some ways these application platforms help reduce the silo-effect between applications when additional information is taken into account. This is partially true, but the full potential is not being realized for the lowly calendar application. The calendar application is under utilized and holds the potential to be a great display vehicle for a person's day, week, month and even year. For example if there is a pre-existing relationship that exists between two or more people then a context can be created about the information shared between them.

In a more sophisticated example when a husband and wife share information within an application platform offering a calendar, task and Todo assignment, shopping information, photo and messaging exchange it should be possible to add value into that shared calendar based on the marriage to improve the overall experience of using the application platform itself. Similarly if a manager of a team of five were sharing a calendar and task assignment application it should be possible to make use of additional relationship-based information to make that calendar experience richer. Currently users are unable to look at the calendar and ask simple questions like what work has been done over the past month by the team, what photographs have I shared over the past month with my wife, what phone calls were made last week to my wife and other such personal questions.

Therefore be it resolved a solution is still required to reduce the silo effect between calendar and other applications. A solution is also required to address the problem of how to use relationship and contextual information within the calendar to make the overall experience richer for all users.

### BRIEF DESCRIPTION OF THE DRAWINGS

FIG. 1 is an illustration of an exemplary auto-journaling calendar screen in month view with summarized information shown.

FIG. 2 is an illustration of an exemplary auto-journaling calendar screen in month view with another set of summarized information shown.

FIG. 3 is an illustration of an exemplary auto-journaling calendar screen in month view showing additional features of the system.

FIG. 4 is an illustration of an exemplary auto-journaling calendar screen in day view with several options for seeing summarized information.

FIG. 5 is an illustration of an exemplary configuration screen within an auto-journaling calendar application to select what information is displayed in month view.

FIG. 6 is an illustration of an exemplary configuration screen within an auto-journaling calendar application to select what information is displayed in day view.

FIG. 7 is an illustration of an alternative embodiment for building a contextual relationship used by an auto-journaling calendar application.

FIG. 8 is an illustration of an exemplary design for creating a auto-journaling calendar application.

FIG. 9 is a data flow diagram showing the steps in one embodiment of the calendar application.

### DETAILED DESCRIPTION OF DRAWINGS

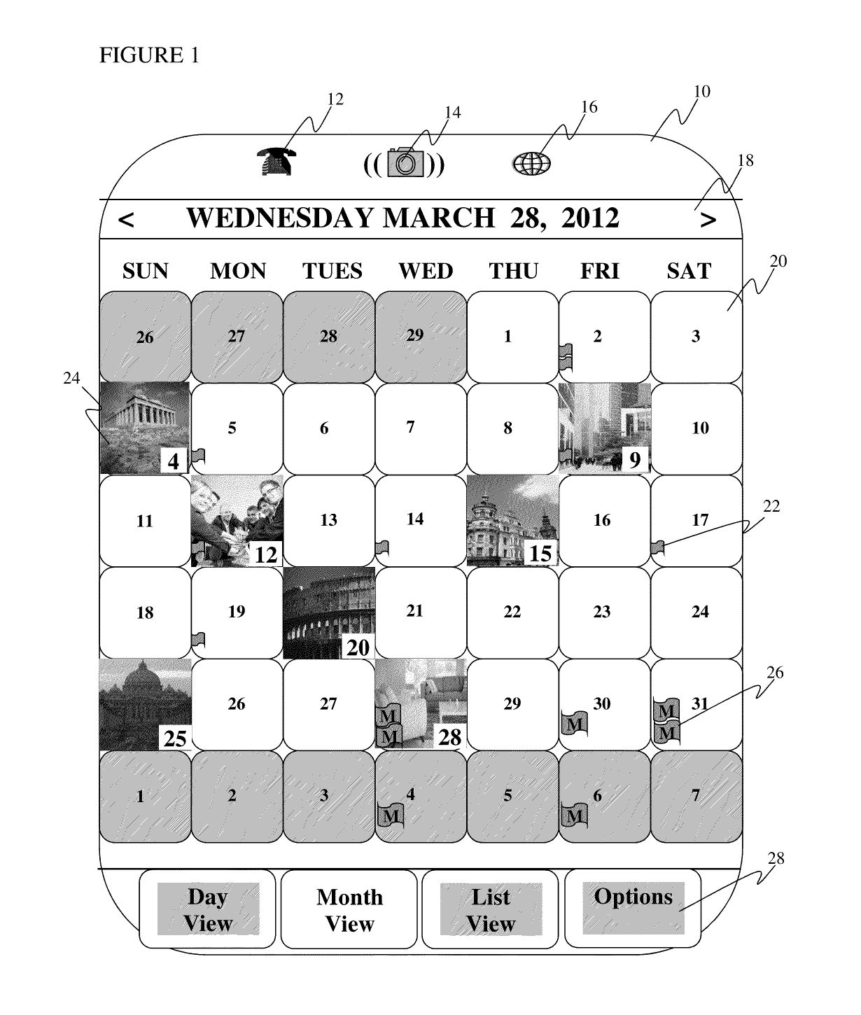

Turning to FIG. 1 there is an illustration of an exemplary auto-journaling calendar screen 10 in month view with summarized information shown. There are a myriad of ways to display traditional calendar information but this simplified embodiment also illustrates how auto-journaling works within the month view. In this embodiment a series of icon's 12, 14, 16 are shown for the user to select using a mouse, cursor or screen touch mechanism. In other embodiments the presence of icon's may not be necessary for example when using a platform calendar design discussed in detail later. In this example the camera icon 14 has been selected by the user. The presence of these icon's over other icon's is selected by the user in the options screen, discussed in later figures. In this simplified view just three icon's are shown but there could be many more or even less icon's shown depending on the screen space and ergonomic design. As already mentioned in a platform environment where the calendar is integrated with messaging, task, photo sharing, texting and other services the need to have icon present could be easily eliminated.

For this illustration the auto-journaling calendar display shows a title line 18 that provides the day and month to the user to help orient them to where they are in the calendar. In this embodiment little arrows 18 are also shown to allow the user to navigate to previous or future months. Each of the days of the month is shown as a separate box 20 with a number indicating with day of the month it represents. In previous days (before today's date), a flag is shown 22 to indicate that an appointment exists on that day. On today's date, and future days the indicator has been made to change to indicate a ‘Meeting’ is to take place 26. In exemplary embodiments this indicator could shown ‘M’ for meeting, ‘A’ for appointment, ‘V’ for video conference and other interesting symbols to be useful for the user. In this embodiment there is a series of large buttons 28 that can be selected by the user. Currently the ‘Month View’ button is selected.

A key part of the exemplary auto-journaling calendar is that for past time the calendar auto-populates the days with information based on an established context. In this embodiment, with the user having selected the photo icon, pictures have appeared 24. As described in greater detail later the pictures have been exchanged with a specific person, like a wife or significant other. The series of pictures on calendar days 4, 9, 12, 15, 20, 25 and 28 represent a photo journal of what I have done and shared with that person throughout the month. With such an auto-journaling method in place the user can determine at a quick glace what they have shared, what is left to share and what they have been up to over the past month. It could indicate trips, the amount of travel, serious issues that are taking place and a wide host of other things. By making the summary of photos context specific the amount of information is reduced and the summary can highlight key aspect of a special relationship. This relationship could be a work relationship, a parent-child relationship or a husband-wife relationship.

If the user wants to look at other journalized summaries they simply need to click on the icons above 12, 16 to see other summaries built by the auto-journaling calendar application. Each summary can produce other realizations like ‘how often have I called into the office’, ‘how frequently have I been speaking to my wife and the kids’, ‘how many tasks have the team I am managing completed’ and many other of conclusions that a user might want to draw. Seeing one's life summarized over a month in different ways can produce a wide variety of information leading to useful conclusions for the person performing the actions. The selection to show summaries is also arbitrary due to the amount of screen space available on the month view. Depending on the physical screen size, i.e. a desktop 23 inch flatscreen monitor verses a 5 inch smartphone monitor, different choices could be made. Once skilled in the art could easily change the summary display to a listing of emails or text messages on that day and allow the user to scroll the list on the month view itself. With touch-screen technology such advanced interface are easily achieved.

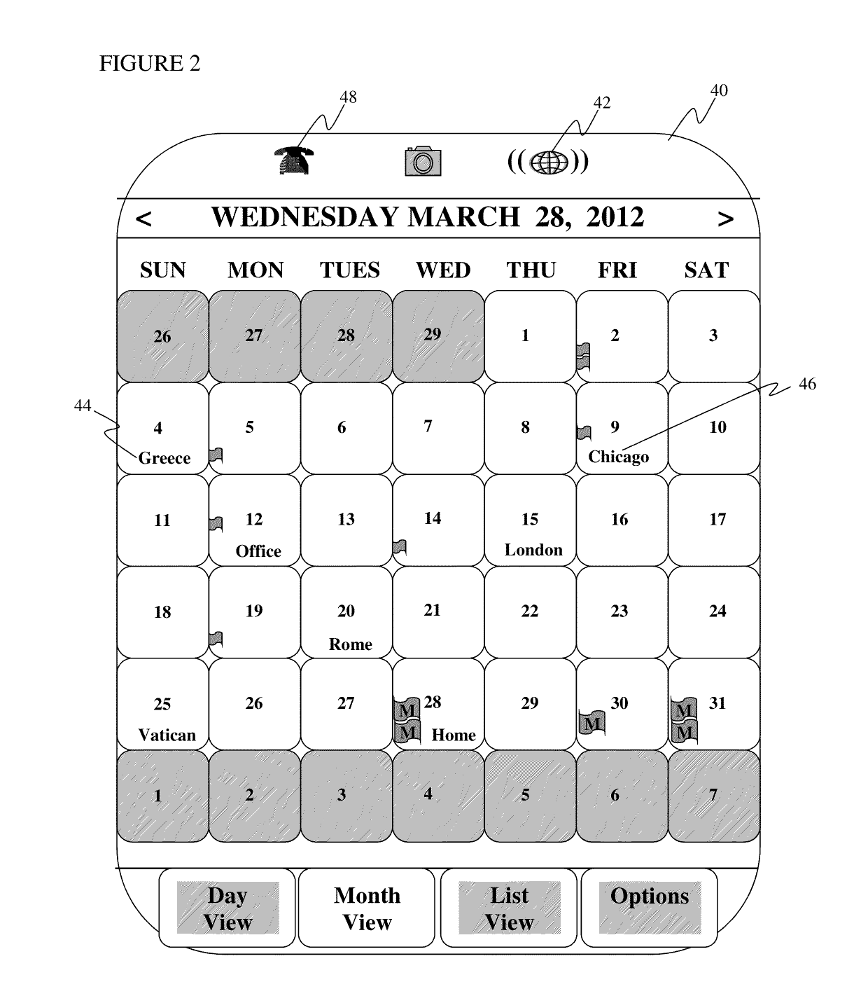

Turning to FIG. 2 there is an illustration of an exemplary auto-journaling calendar screen 40 in month view with another set of summarized information shown. In this example the user has selected the globe 42 representing GPS location summaries. GPS locations might be summarized by taking a snap shot of the user's location at a specific time in the day, the user might perform a ‘mark location now’ type procedure or they might set a distance parameter to account for large distances. Alternatively instead of a summary the user might decide to see all their GPS locations and scroll up and down through the list to see where they have been that day. For a traveling salesperson this would be indispensable for determining where they have made sales calls and where they still must visit. In this example there user appears to be in Greece 44 on the March 4^{th} and then Chicago 46 on March 9^{th}. The point of the summary is to allow the user to take a quick glimpse of where they've been over the past month to help with determinations and to answer questions for themselves. The advantage of the auto-journaling and summarizing method is primarily known by the user. Therefore the types of summarizes can vary dramatically as each and every individual might want to see something a little different.

Other examples could be provided but a similar pattern would be revealed. If the user selected the phone icon 48 the month view would be populated with a summary of phone calls or every phone call as configured by them. It might show the summary of calls made to their wife, all the calls made to their wife, the total number of calls each day, the total number of minutes spent on the phone each day or some other even more advanced information summaries. A manager of a development team might ask to see a Todo or task list summary, indicating which tasks have been completed. A quick view of the month view might reveal how well a project is progressing. In other embodiments applications can be built that feed information into the calendar, like financial transactions, diet or weight loss indicators, video exchanged, email message, text messages and all other forms of communications. For one skilled in the art of data communications it is obvious that wired or wireless communications could be used on smartphones, cell phones, tablet, laptop or desktop computers.

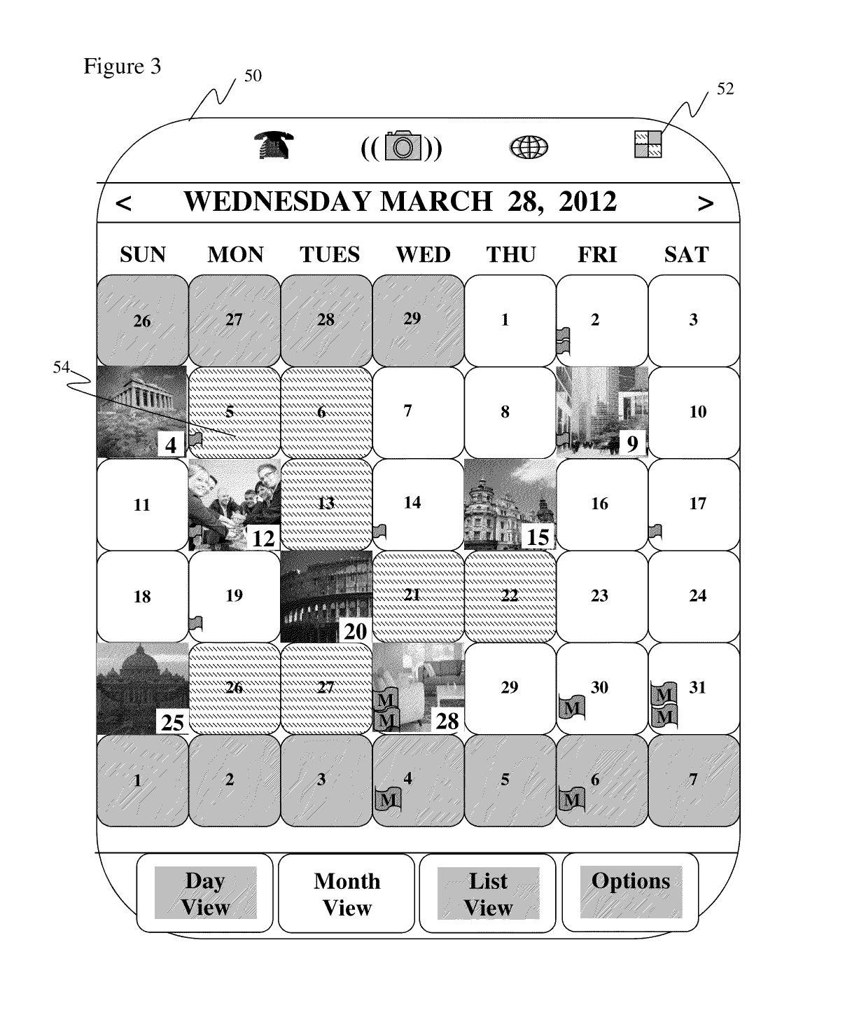

Turning now to FIG. 3 there is an illustration of an exemplary auto-journaling calendar screen 50 in month view showing additional features of the system. The addition of an icon selection 52 is used to represent another advanced feature of the auto-journaling calendar application. Although a button is shown to give the user maximum flexibility it would be possible for the auto-journaling calendar application to perform this automatically based on programming or based on a configuration step made by the user. One such configuration screen is shown later in this application.

By pressing the button 52 the user requests the calendar to correlate the information gathered each day to modify the month-view screen display to show statistical or calculated information in a visual way. For example the user might be looking for patterns like ‘what is a crazy busy day for me?’, ‘when do I feel under-worked and bored?’, ‘when are my wife and I not getting along very well?’, ‘when am I traveling too often?’ and many, many more type inquires. The user can set guidelines and parameters to help the auto-journaling calendar to illustrate when limits are reached or patterns are appearing in the data.

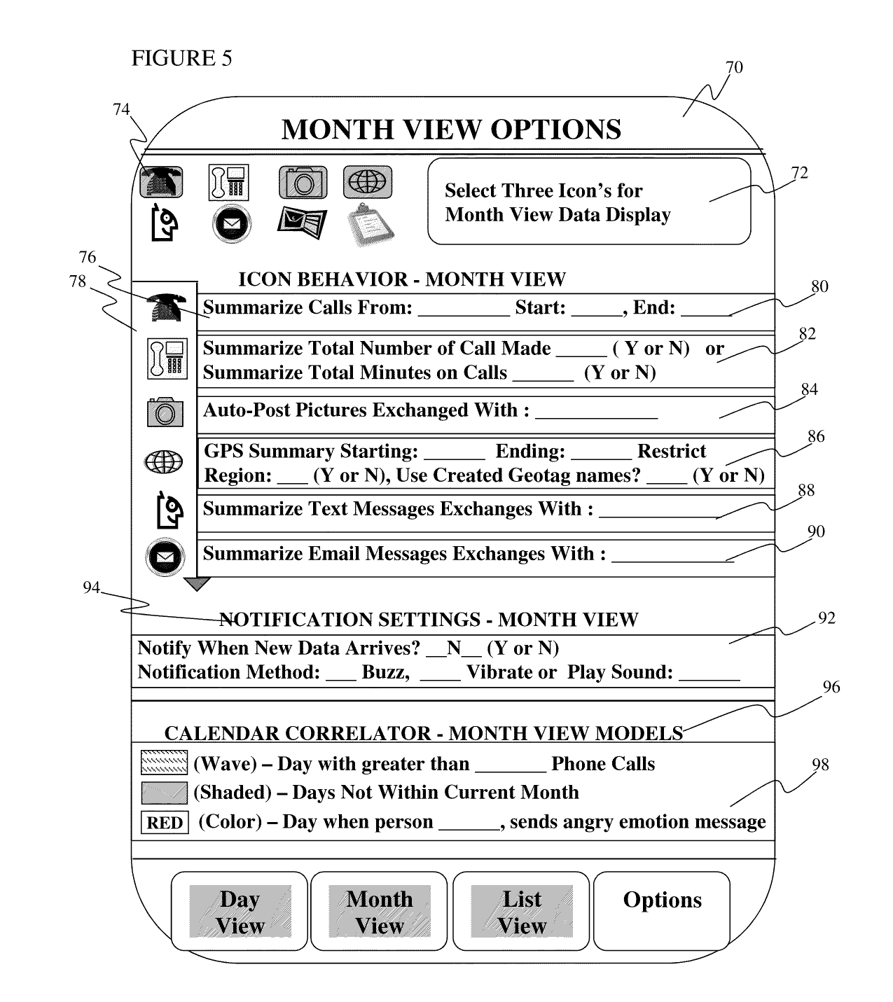

In this illustration the user has pressed button 52 and wave patterns have appeared 54. The wave patterns is found on month days 5, 6, 13, 21, 22, 26 and 27. As illustrated in FIG. 5 this is meant to represent days when the total number of phone calls exceeded a given number. So the user might be determining which days have excessive phone calls. Perhaps they are trying to correlate too many phone calls with excessive stress in their lives. Alternative perhaps they are trying to determine why they are not productive at work and trying to see if excessive phone calls are correlated with too many interruptions to get productive work done. The point is the user will understand what the day means for them in their lives through the configuration screen and through seeing the result of their lives in the auto-journaling calendar.

This new level of display can be used in conjunction with elements of the display already discussed. So I could still be showing GPS location transitions summaries and show wave patents on days where GPS locations exceed 100. Alternatively I could show GPS location summaries and wave patterns for excessive phone calls made. The correlation of data sets can tell productive people when there is a problem and how to address it. This additional functionality shows how the overall practicality of the system is maximized once the data has been collected and correlated by the auto-journaling calendar application. With the user's guidance the system can be made to summarize and correlate almost any data within a system.

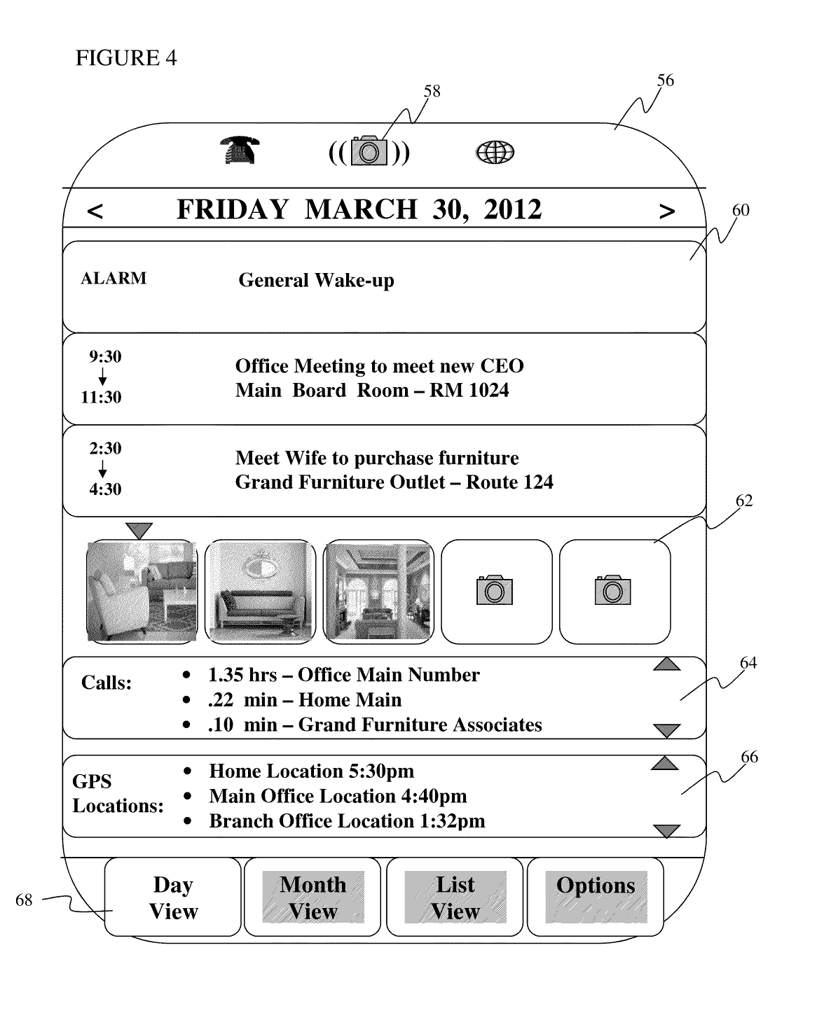

Turning now to FIG. 4 there is an illustration of an exemplary auto-journaling calendar screen 56 in day view with several options for seeing summarized information. As with any user interface there is a myriad of ways to present a day summary calendar view, this is one such embodiment. In this embodiment there are three selected icons, similar to the ones shown in the month view. In this example the camera icon 58 is selected which simply places that information more proximately on the day view summary screen.

The first section shows a summary of appointments and meetings 60, each with a time and a length display. In this auto-journaling calendar the normal summary of appointments is followed by a summary of data from other applications 62, 64, 66. The first type of other data shown is the photos exchanged 64 with the selected person. In this embodiment the first one is highlighted automatically and used in the month view of the auto-journaling calendar. However the user might want to change the automatic selection to the second, third, etc. This other information is the first displayed because it has been selected by the user.

Also shown in this day view are the Call Summary 64 and the GPS summary 66. These additional summaries have smaller screens space but scroll button are provided to show other information is present. Using cursor or touch screen methods the user can see this other information areas. Finally the large button second has the day view 68 selected.

Turning to FIG. 5 there is an illustration of an exemplary configuration screen 70 within an auto-journaling calendar application to selecting what information is displayed in month view. The option screen guides the auto-journalizing calendar program to determine what to display in the month view. The division of month view and day view is presented for this embodiment but it is well understood that these two view could also be merged and follow one configured setting. These options will inform the auto-journaling calendar exactly which data to summarize and prioritize for the user's month visualization view. First the user is allowed to select some number of icon's 72 for the main screen. Although three icons could be selected it could be a larger or smaller number. The use of icon's is also arbitrary, it could be a letter, a hot key on the computer, a sound, a time of the day or many other methods. In other embodiments the user might want to automatically show GPS locations in the morning, but then phone call summaries in the afternoon and photos exchanged in the evening. For one skilled in the art of configuration management the permutations of configuration settings is vast and this is just one embodiment.

In this embodiment the user selects three icons 74, shown in this example with icons surrounded by grey boxes. These icon's are then assigned meaning 76. Each icon is shown 78 and the user selects from programmed summary actions 80. There is no limit to the number of actions and how they are assigned. The icon's might be less visually representative then what is shown depending on what the user determines is useful for them. Within each assigned action 80 there can be some overlap, for example the first phone icon is matched to summarizing calls from person ‘X’. They might select the time of the day to limit the summary or it might be the entire day. The very next icon is another phone icon with a different set of parameters 82 related to phone calls. In this example the user can select between the total number of calls made or the total minutes made on all calls 82. For the person programming the calendar auto-journaling summary application the number of types of summaries that can be built is infinite. For phone calls it might be useful to see the total number of incoming calls or perhaps the total number of long distance calls the list is endless.

Other summary examples are provided only to represent all the interesting ways the auto-journaling calendar could be built. The next example is the summary of pictures exchanged with a specific person 84. In this embodiment the calendar will automatically post the most recent or selected picture for each day exchanged with a specific person. This is followed by the GPS summary that limits changes to a start time and end time and even restricts the region 86. In this embodiment this illustration uses geotags created by the user. For example when they are at home they mark that location with the tag HOME and when they are at work they mark that location as OFFICE, etc. Following this is a summary of text messages exchanged with a person 88, then a summary of email messages exchanged with a person 90

There could be a range of other settings and configuration data provided to the user. In this simplified example the user is provided with a Notification Settings 94 option. In this option the user is given a range of choices 92, but there could be many other choices provided. The user can decide to do some form of notification and then select the notification method 92. They might select to vibrate, buzz or play a sound when new items are automatically posted onto the calendar display 92. In other embodiments they might be given the opportunity to set a notification method for the three selected icons that are on the main screen.

The final section allows the user to configure the correlation elements of the calendar 96. The number of patterns to configure could be very large and only three are shown here. There could also be action-based calendar boxes like vibrate or wiggle, along with color there could be colorized wave patterns as well. For each different calendar correlation boxes shown the user can select different parameter limits to determine when a calendar month box should be visually modified 98. For a programmer of the auto-journaling calendar the number of patterns, limits and statistical models that could be very large. For anyone skilled in the art the challenge to limit such large numbers would be to determine what does the user care to know about, what will help them in their day and life.

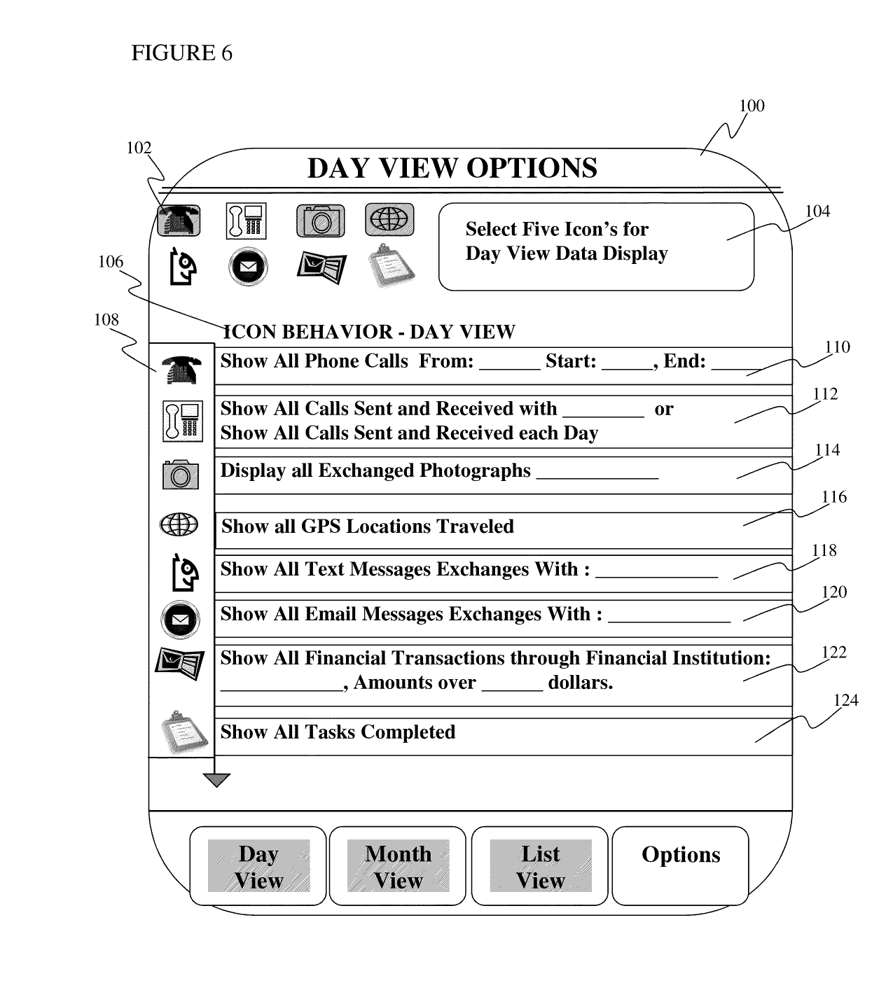

Turning to FIG. 6 there is an illustration of an exemplary configuration screen 100 within an auto-journaling calendar application to select what information is displayed in day view. In this embodiment the choices for month and day view have been split to provide the user with maximum flexibility. For one skilled in the art the visual presentation of a calendar month verses a calendar day are vastly different. This split allows the user to use greater amounts of summarized information on the month view and much less summarized information on the day view.

In this embodiment the user again selects a certain number of icons 104 from a selection of many icons 102. The total in this illustration is five, greater than shown in the month view configuration screen 70. Just as shown in FIG. 5 the next section allows the user to select the

Icon behavior in day view mode. Screen section 108 lists the icons and beside each icon a behavior is selected. In this embodiment the first behavior 110 is to show all calls from a person, from a starting time to an ending time. This is followed by an option to show all calls sent and received with a person or show all calls sent and received for the entire day 112. Then the camera icon can be used to show all exchanged photographs 114. This might be useful for determining what has left your computer and been seen by others. The next configured icon is to show all GPS locations traveled in a day 116. The next two icons allow the user to see all text messages exchanged with a person 118 and all email messages exchanged with a person 120. The next icon can be used to show all financial transactions made through financial institution ‘ABC’ with amounts over a certain amount of dollars 122. Finally there is an icon to show all tasks completed 124.

This list of configuration elements has been created for illustration purposes and one skilled in the art would recognize that the number and type of choices for the user would be based on the system the auto-journaling calendar is running within.

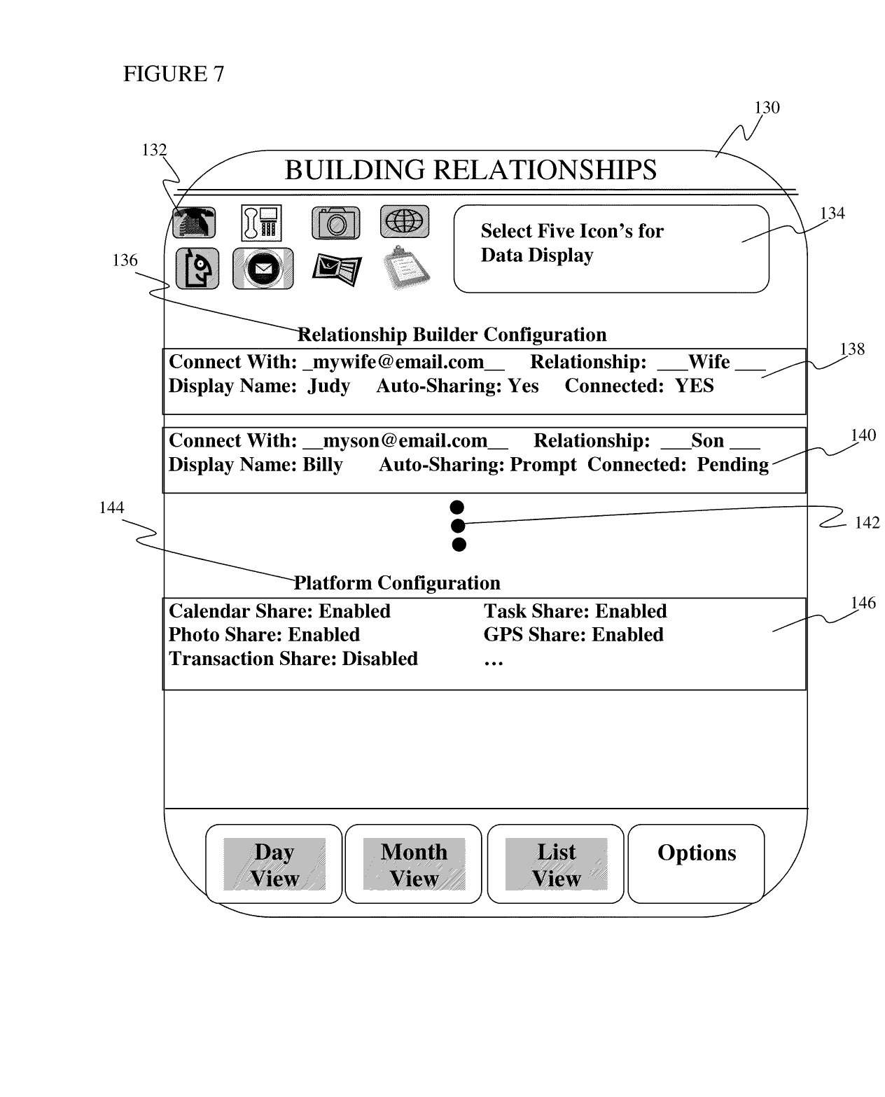

Turning now to FIG. 7 there is an illustration of an alternative embodiment for building a contextual relationship used by an auto-journaling calendar application 130. In the earlier example the options screen was used to build or infer relevance of certain information. For example one could select to show photographs exchanged with a certain person by pulling their name from the address book, or by using an email address. In this alternative embodiment the user is working within a platform environment where relationships are pre-built into the system 130. Many new social network systems are built this way for example Facebook™ and Linkedin™ are two such systems where friendships and business relationships are central to the systems existence.

In this embodiment there is a dedicated screen for building a relationship with one or more people 130. In this embodiment the user can again select five icons 132 for modifying the data displayed 134 on the auto-journaling calendar screen. It should we recognized that depending on the amount of data available such icons would not be necessary and the auto-journaling calendar would simply default to show exactly what the programmers have determined is necessary for the system. Such simplified decision making ability is often important in complex systems.

The first section allows the user to configure an actual relationship 136. In this embodiment the family is the type of relationship being built so a wife or husband might be the first person to configure 138. This might be followed by one or more children 140. Within each relationship there could be additional choices like relationship type wife, husband, girlfriend or common-law partner. The user might also have the choice of adding a display name, similarly to a friendly name in email addresses. There might be a choice whether to turn-on auto-sharing. In many systems this could be turned on by default, but for some people you might want to over-ride the default setting. Finally there could be a status indicator to show whether the person you are trying to build a relationship with has accepted the relationship request. There could be many, many type relationships being built 142. There could be business relationships, partnerships, work groups, study groups, classmates, drinking partners, team mates and a myriad of different social groups.

In this embodiment the second section shows a platform configuration 144. In a platform environment many different sub-programs might live within the one overall environment. In this embodiment there are five different sub-programs shown 146 and many more possible. There is a calendar, task, photo, GPS and transaction sharing option with the ability to enable or disable each one individually.

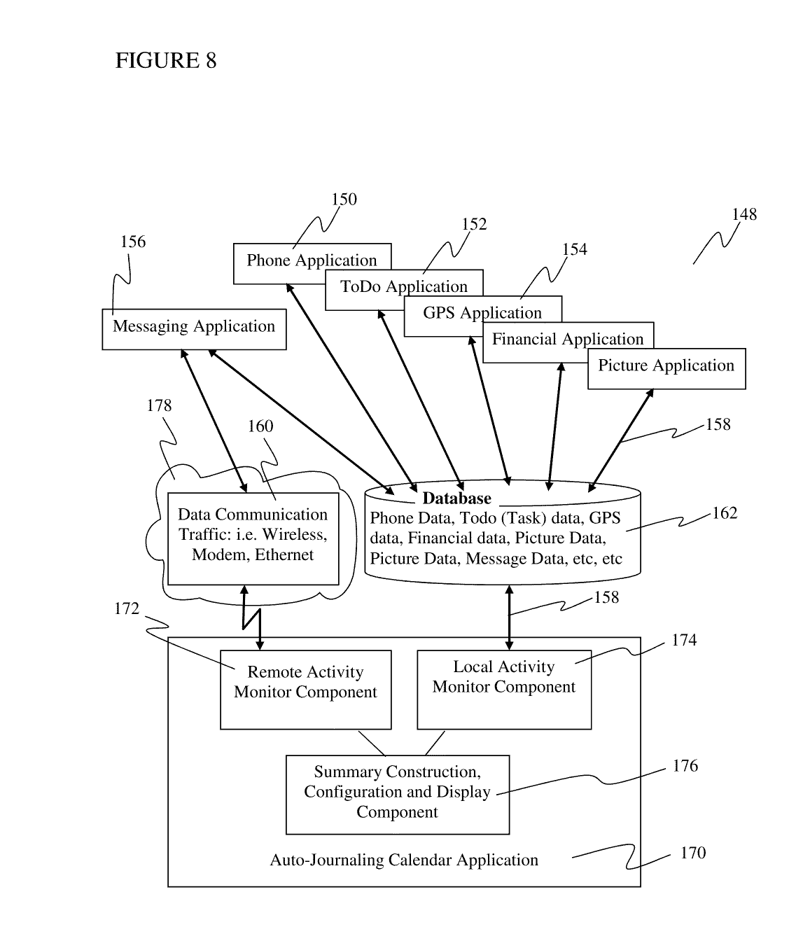

Turning to FIG. 8 there is an illustration of an exemplary design for creating an auto-journaling calendar application 148. The exemplary auto-journaling calendar application is monitoring information sources other than those entered by the user within the calendar itself. For one skilled in the art there are many well known ways to monitor data from other applications. In this embodiment a database method will be described to enable the auto-journaling calendar application's advanced auto-journaling summary methods.

Within the computer system, whether it is a smartphone, tablet, laptop, netbook, desktop or some other unique computer configuration there will be a wide range of cooperating applications. All computer systems have a database 162 or file system engine to allow applications to store and access data. In this example we highlight the Phone Application 150, the Todo or Task Application 152, the GPS Application 154 and the Messaging Application 156. These are interacting with the file-system and related database engine 162 using a standard method 158, normally based on application program interfaces (APIs), TCP/IP interface methods and other well known methods. The database represents a large data repository that is normally segmented into individual silos of information. Exceptions to that include the universal inbox viewing application that allows a user to list, change and modify many elements of data within the database 162. Along this same vein the Auto-Journaling Calendar Application 170 interfaces 158 to the database engine 162 to perform a similar monitoring activity. Additional support is also provided by data communication sub-systems 160 that provide functionality to move data to and from other places. Such methods are very well known including physical wires and wireless methods within computer systems.

Within the Calendar Application 170 are components like the Local Activity Monitor Component 174, the Remote Activity Monitor Component 172 and the Summary Construction, Configuration and Display Component 176. These are representative components to highlight the additional functionality needed to enable the auto-journaling and summary behavior discussed in this application. To keep abreast of changes within the database 162 the Local Activity Monitor Component 174 regularly checks for changes into applications the user has asked it to monitor. As shown in earlier figures the user can select several applications (three in previous examples) to monitor and summarize the information gathered. It is also well known that such methods of checking can be enhanced through database 162 alert mechanisms so that polling the database 162 is not required.

The Remote Activity Monitor Component 172 performs a similar role for applications that perform data communication 160 activities. Supporting the data communications system could be an Internet-based cloud 179. The Internet cloud concept refers to an off-device storage model used commonly now with many environments. For example the Apple Computer's iCloud™ is one such example known widely to those in the computing field. In this illustration the Messaging Application 156 is shown using both the database 162 and the data communication 160 services. Messaging Application 156 could include text messaging, email messaging, MMS messaging, instant messaging and a wide collection of other methods. The Remote Activity Monitor Component 172 might use a TCP/IP monitoring method to determine when data is exchanged between other remote components and the cloud storage system. It might use this information as a trigger to look within the database 162 to see what was sent or received. There could also be a polling model or a notification system used to tell the Remote Activity Monitor Component 172 when data has changed in the cloud from other connected computers.

Important changes to the database 162 are then collected by these components 172, 174 and passed to the Summary Construction, Configuration and Display Component (Summary) 176. Summary 176 then allows the user to interact with the data to select those parts that are important to them. Programmatically different methods are used to display the data and summaries are built based on programmed calculation methods. The calendar application was selected for this summary activity because of the unique format it provides when presenting the user back to the user. It is anticipated that other application could also be used to provide this overview of the data. A custom application could be built to show activity over a three month, year or multi-year format. Such displays are common in stock portfolio presentation but this information is all the stock applications deal with. The auto-journaling calendar takes all data within an application relative to a user and summarizes it for viewing by the user. By using a platform environment and a cloud style of information storage, the creation of a auto-journaling calendar becomes easier and even more straightforward for the user. With less configuration and relying on pre-established relationships a unique context can be created between the data and the people exchanging the data.

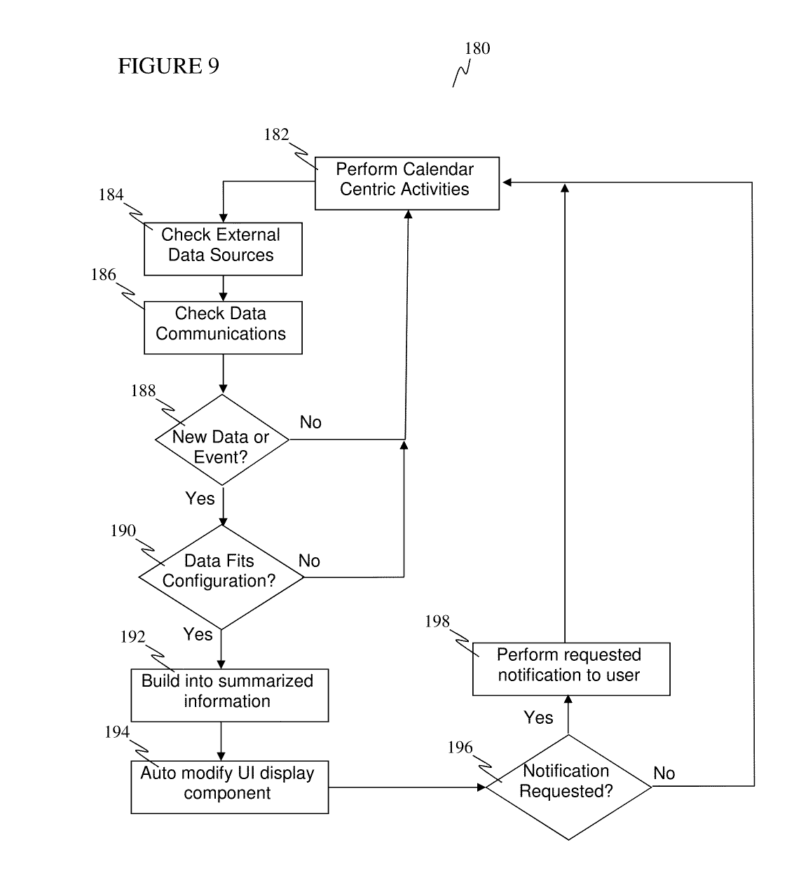

Turning to FIG. 9 there is a data flow diagram 180 showing the steps in one embodiment of the auto-journaling calendar application. The dataflow for a normal calendar application would be far too complex for this illustration. To simply the data flow all traditional calendar behaviors are placed within Perform Calendar Centric Activities 182. Within this step is contained many tasks associated to calendars. For example a few of these steps include: allowing the user to input appointments, setting alarms, regular calendar settings, normal calendar user interface views, displaying reminders, etc. However added to these activities is a component that checks external data sources 184. These data sources could include local database sources and even data stored on external media like a memory stick. Further checking is also performed on data communication pathways like TCP/IP, wireless, Ethernet links and perhaps Bluetooth monitoring, Near Field Communication (NFC) interface monitoring and other forms of data communications 186. These checks could involve interaction with a cloud data storage model where data from all relationship-based computer systems exchange data 186.

A check is then performed to see if any new data or event has been detected 188? If not then the program returns to perform other calendar centric activities 182. If there is new data or event information a further check is performed to see if it matches the data requested by the user within the configuration section 190. If the data does not match then the program returns to perform other calendar centric activities 182. If the new data or event does fit the configured options set by the user 190 then it is collected and built into the summary data calculated by the calendar 192. Once the calculations are performed to summarize what has been found any User Interface (UI) modifications are performed to the display component 194.

Once all areas are updated, including the user interface elements, the program checks to see if the user has requested to be notified 196. If notification is not requested 196 the program returns to perform other calendar centric activities 182. Otherwise the necessary notification is executed for the user 198 and the program returns to perform other calendar centric activities 182.

What is claimed is:

1. A system and method for creating an auto-journaling calendar application comprised of:
a) monitoring data and events from within an auto-journaling calendar application,
b) matching changes to the data and events to a time and day when the data and events take place,
c) allowing the correlation of changes to the data and events following programmed parameters;
d) automatically posting change detected to the auto-journaling calendar such that:
i) data and event changes can be seen by the user over a period of time in various auto-journaling calendar views.

2. A method of claim 1 wherein the summary of changes further involves:
a) performing calculations on the information to produce a mathematical summary on the information.

3. A method of claim 2 wherein the mathematical summary on the information involves:
a) the modification of each cell of a month view to indicate a mathematically relevant piece of information following configured settings created by the user.

4. A method of claim 1 wherein the automatically posting a change to the calendar further involves:
a) if requested by the user performing a notification when a change is automatically made to the calendar.

4. A method of claim 1 wherein the data and events includes:
a) the ability to detect a change to the data combined with an event on that changed data.

5. A method of claim 4 wherein the combined data and event includes:
a) the creation of a picture combined with the event of sharing that picture with another person.
